(19) United States
(12) Patent Application Publication
(10) Pub. No.: US 2009/0232496 A1
(43) Pub. Date: Sep. 17, 2009

(54) OPTICAL COMMUNICATION APPARATUS, OPTICAL TRANSMISSION SYSTEM AND METHOD FOR REDUCING NONLINEAR DEGRADATION

(76) Inventor: Hideki OKUNO, Tokyo (JP)

Correspondence Address: NEC CORPORATION OF AMERICA, 6535 N. STATE HWY 161, IRVING, TX, 75039, US

(21) Appl. No.: 12/403,053

(22) Filed: Mar. 12, 2009

(30) Foreign Application Priority Data
Mar. 17, 2008 (JP) 2008-067788

(51) Int. Cl. H04J 14/00

(52) U.S. Cl. 398/43

(57) ABSTRACT

This invention provides an optical communication apparatus in which the nonlinear degradation of a wavelength multiplexed signal in the nonlinear degradation factor member causing the nonlinear degradation is reduced, an optical transmission system using the same, and a method for reducing the nonlinear degradation. There are provided a wavelength interval enlarging portion 51 for enlarging a wavelength interval of an inputted wavelength multiplexed signal, a nonlinear degradation incidental processing portion 52 for applying arbitrary processing involving the nonlinear degradation to the wavelength multiplexed signal whose wavelength interval is enlarged, and a wavelength interval recovering portion 53 for recovering the wavelength interval of the wavelength multiplexed signal to which the arbitrary processing is applied to the original wavelength interval.

This application is based upon and claims the benefit of priority from Japanese patent application No. 2008-067788, filed on Mar. 17, 2008, the disclosure of which is incorporated herein in its entirety by reference.

### BACKGROUND OF THE PRESENT INVENTION

1. Field of the Present Invention

The present invention relates to an optical communication apparatus, an optical transmission system, and a method for reducing nonlinear degradation that reduce the nonlinear degradation of a wavelength multiplexed signal in a nonlinear degradation factor member causing the nonlinear degradation.

2. Description of the Related Art

An optical relay including a dispersion compensation fiber and an optical amplifier as factors to cause nonlinear degradation is shown in FIG. 1. In FIG. 1, an optical amplifier 51 amplifies an inputted wavelength multiplexed signal kept in the light state and outputs it to a dispersion compensation fiber 52. The dispersion compensation fiber 52 compensates for degradation caused by wavelength dispersion of the wavelength multiplexed signal. An optical amplifier 53 amplifies the wavelength multiplexed signal inputted from the dispersion compensation fiber 52 kept in the light state and outputs it.

A path from an input of the optical amplifier 51 to an output of the optical amplifier 53 constitutes a single stage of a relay, and transmission path fibers 54 and 55 are connected to the input side of the optical amplifier 51 and the output side of the optical amplifier 53 so as to constitute an optical transmission system. To this optical transmission system, a wavelength multiplexed signal with a wavelength interval of 50 gigahertz and 80 channels is transmitted.

In order to reduce the nonlinear degradation in the transmission path fibers 54 and 55, the output of the optical amplifier 53 is limited to 0 dBm per channel. Since a loss of the transmission path fibers 54 and 55 is 15 dB, the input of the optical amplifier 51 is −15 dB per channel. Also, a noise factor of the optical amplifiers 51 and 53 is 7 dB, and a loss of the dispersion compensation fiber 52 is 12 dB.

Suppression ratio to a signal light of four optical wave mixing causing the nonlinear degradation is in proportion to the square of the input to the optical fiber, in inverse proportion to the fourth power of the wavelength interval and in inverse proportion to the fourth power of a mode field radius of the optical fiber. Since the mode field radius of the transmission path fibers 54 and 55 is 10 μm while the mode field radius of the dispersion compensation fiber 52 is 5 μm, the four optical wave mixing of as much as 16 times of that of the transmission path fibers 54 and 55 is generated in the dispersion compensation fiber 52.

In order to reduce the input of the dispersion compensation fiber 52 and cancel it, the input of the dispersion compensation fiber 52 needs to be lowered to −6 dB. Under this condition, the noise index of the relay as a whole is 11.8 dB, and if an optical signal to noise ratio at a receiving end is 20 dB or more, transmission in 13 spans is limited.

As mentioned above, in the optical relay including those causing the nonlinear degradation (nonlinear degradation factor member) and the optical amplifier, there are problems that:

(1) since the wavelength interval in the nonlinear degradation factor member is small, if the input to that is not lowered, the nonlinear degradation occurs in the relay; and

(2) if the input to the nonlinear degradation factor member is lowered, noise degradation occurs in the relay.

Technologies relating to optical transmission using the wavelength multiplexed signal include “optical transmission system” disclosed in Japanese Patent Laid Open Publication No. 2000-124857 and “method and apparatus for managing dispersion in optical communication system” disclosed in Japanese Patent Laid Open Publication No. 2006-109477.

### SUMMARY OF THE INVENTION

However, the invention disclosed in Japanese Patent Laid Open Publication No. 2000-124857 does not describe the nonlinear degradation at all or does not solve the problems in the above (1) or (2).

Also, in the invention disclosed in Japanese Patent Laid Open Publication No. 2006-109477, it is supposed that the nonlinear degradation occurs not in the nonlinear degradation factor member but in a transmission path. Moreover, since the wavelength interval in the nonlinear degradation portion is not different from the wavelength interval on the transmission path at all, the problems in the above (1) and (2) occur.

As mentioned above, a method for reducing the nonlinear degradation in an optical communication apparatus including the nonlinear degradation factor member causing the nonlinear degradation has not been provided.

The present invention was made in view of the above problems and has an exemplary object to provide an optical communication apparatus in which the nonlinear degradation of a wavelength multiplexed signal in the nonlinear degradation factor member causing the nonlinear degradation is reduced, an optical transmission system using the same, and a method for reducing the nonlinear degradation.

In order to achieve the above exemplary object, the present invention provides an optical communication apparatus according to a first exemplary aspect of the invention including wavelength interval enlarging means for enlarging a wavelength interval of an inputted wavelength multiplexed signal, means for applying arbitrary processing involving nonlinear degradation to the wavelength multiplexed signal whose wavelength interval is enlarged, and wavelength interval recovering means for recovering the wavelength interval of the wavelength multiplexed signal to which the arbitrary processing is applied to the original wavelength interval.

Also, in order to achieve the above exemplary object, the present invention provides an optical transmission system according to a second exemplary aspect of the invention including the optical communication apparatus according to the first aspect of the present invention, a first transmission path fiber for inputting a wavelength multiplexed signal to the optical communication apparatus, and a second transmission path fiber for outputting the wavelength multiplexed signal from the optical communication apparatus.

Also, in order to achieve the above exemplary object, the present invention provides a method for reducing the nonlinear degradation according to a third exemplary aspect of the invention including steps of enlarging a wavelength interval of an inputted wavelength multiplexed signal, applying arbitrary processing involving nonlinear degradation to the wavelength multiplexed signal whose wavelength interval is enlarged, and recovering the wavelength interval of the wavelength multiplexed signal to which the arbitrary processing is applied to an original wavelength interval.

### BRIEF DESCRIPTION OF THE DRAWINGS

The exemplary objects and features of the present invention will become more apparent from the consideration of the following detailed description taken in conjunction with the accompanying drawings, in which:

FIG. 1 is a diagram illustrating a configuration of an optical relay including a dispersion compensation fiber and an optical amplifier as factors for causing nonlinear degradation;

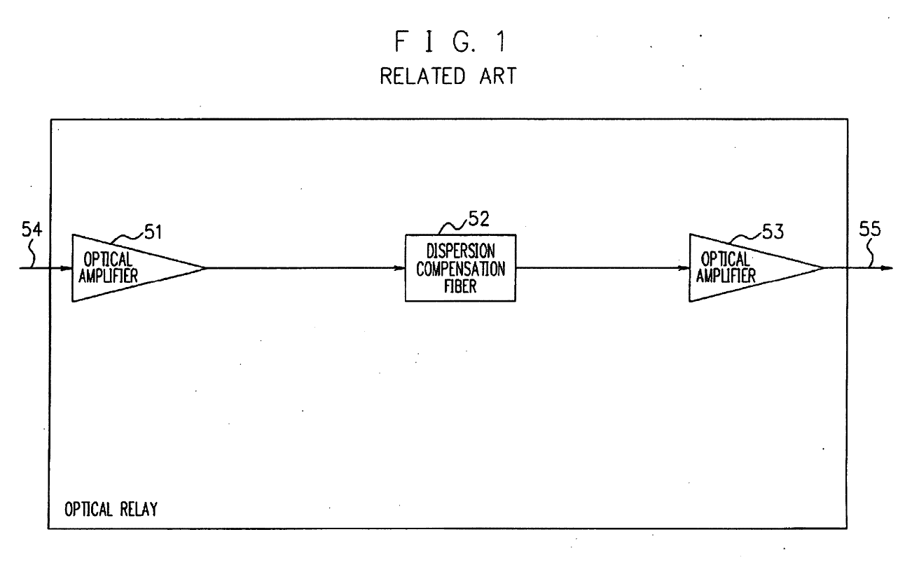

FIG. 2 is a diagram illustrating a configuration of an optical communication apparatus according to the present invention;

FIG. 3 is a diagram illustrating another configuration of an optical communication apparatus according to the present invention;

FIG. 4 is a diagram illustrating a configuration of an optical transmission system according to a first exemplary embodiment of the present invention;

FIG. 5 is a diagram illustrating a configuration of an interleaver of an optical relay according to the first exemplary embodiment;

FIG. 6 is a diagram illustrating a configuration of the optical relay having two pairs of dispersion compensation fiber connection ports between optical amplifiers;

FIG. 7 is a diagram illustrating a configuration of a dispersion compensation fiber module according to the first exemplary embodiment;

FIG. 8 is a diagram illustrating a configuration of an optical transmission system according to a second exemplary embodiment of the present invention;

FIG. 9 are diagrams illustrating configurations of the interleaver of the optical relay according to the second exemplary embodiment;

FIG. 10 is a diagram illustrating a configuration of the optical relay having one pair of the dispersion compensation fiber connection ports between the optical amplifiers; and

FIG. 11 is a diagram illustrating a configuration of the dispersion compensation fiber module according to the second exemplary embodiment.

### DESCRIPTION OF THE EXEMPLARY EMBODIMENT

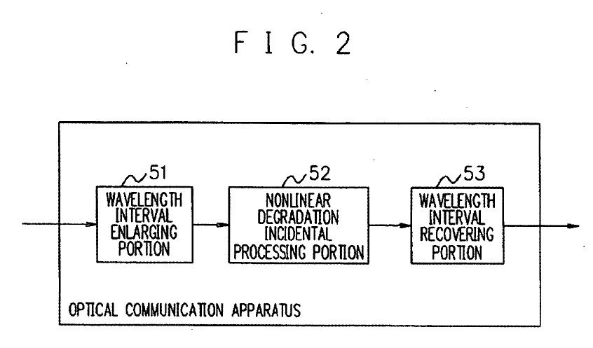

The present invention is to reduce nonlinear degradation by applying arbitrary processing involving nonlinear degradation to a wavelength multiplexed signal after its wavelength interval is enlarged when the arbitrary processing involving the nonlinear degradation is applied to the wavelength multiplexed signal. Specifically, as in an optical communication apparatus shown in FIG. 2, the wavelength interval is enlarged in a wavelength enlarging portion 51, the arbitrary processing involving the nonlinear degradation is applied in a nonlinear degradation incidental processing portion 52, and then, wavelength conversion is applied in a wavelength interval recovering portion 53 so that the wavelength interval of the wavelength multiplexed signal is recovered to the original wavelength interval and made as an output signal.

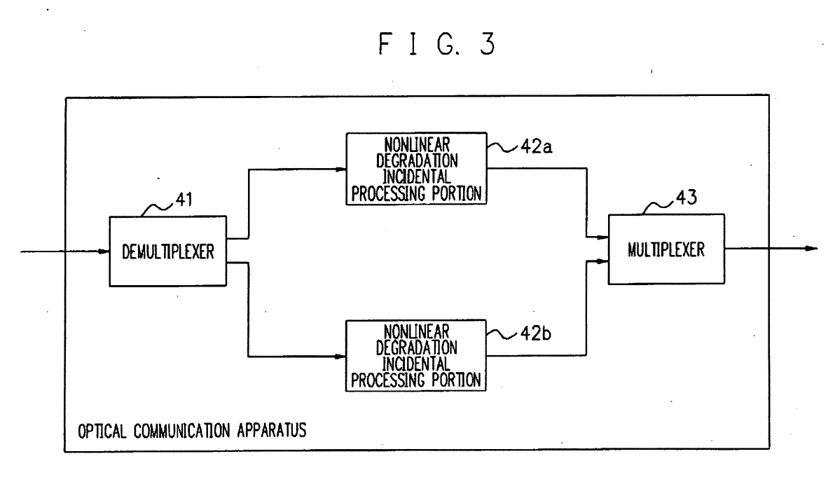

As an example, as the optical communication apparatus shown in FIG. 3, a wavelength multiplexed signal is demultiplexed by a demultiplexer 41 so as to enlarge the wavelength interval, the arbitrary processing involving the nonlinear degradation is applied to each of the wavelength multiplexed signals in nonlinear degradation incidental processing portions 42a and 42b, and the wavelength multiplexed signal after the arbitrary processing involving the nonlinear degradation is applied is multiplexed by a multiplexer 43 and made as an output signal.

By applying the arbitrary processing involving the nonlinear degradation after the wavelength interval of the wavelength multiplexed signal is enlarged as mentioned above, the nonlinear degradation can be reduced.

Exemplary embodiments of the present invention will be described below using a case in which an optical relay is applied as an optical communication apparatus as an example.

### First Exemplary Embodiment

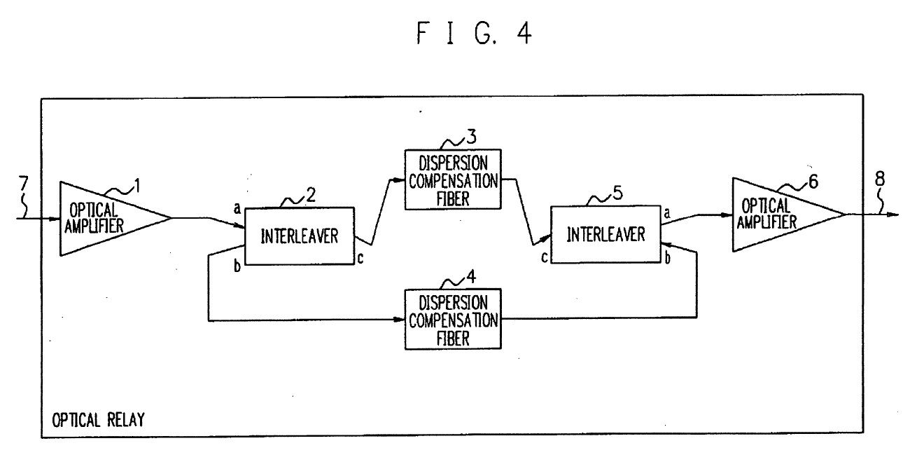

FIG. 4 shows an optical transmission system according to a first exemplary embodiment of the present invention. This system includes an optical relay including dispersion compensation fibers 3 and 4 and optical amplifiers 1 and 6 as factors causing the nonlinear degradation.

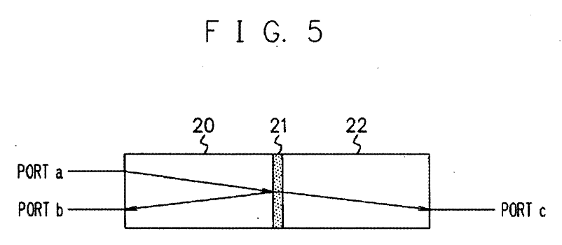

FIG. 5 shows a detailed configuration of an interleaver 2. A wavelength multiplexed signal inputted from a port a of the interleaver 2 advances through a rod lens 20. An odd-number channel is reflected by a multiplexer/demultiplexer film 21 and then, outputted from a port b, while an even-number channel is transmitted through the multiplexer/demultiplexer film 21 and then, advances through the rod lens 22 and is outputted from a port c, respectively. In an interleaver 5, a flow of the signal becomes opposite to that of the interleaver 2. That is, the wavelength multiplexed signal of the odd-number channel inputted from the port b advances through the rod lens 20, is reflected by the multiplexer/demultiplexer film 21 and then, outputted from the port a. The wavelength multiplexed signal of the even-number channel inputted from the port c advances through the rod lens 22, is transmitted through the multiplexer/demultiplexer film 21 and then, outputted from the port a. As a result, in the interleaver 5, the wavelength multiplexed signals inputted from the port b and the port c, respectively, are all multiplexed and outputted from the port a.

In FIG. 4, the optical amplifier 1 amplifies the inputted wavelength multiplexed optical signal kept in the light state and outputs it to the interleaver 2. The interleaver 2 demultiplexes the wavelength multiplexed signal inputted from the port a into an odd-number channel and an even-number channel and outputs two pairs of the wavelength multiplexed signals whose wavelength interval is enlarged from the port b and the port c, respectively. The dispersion compensation fibers 3 and 4 compensate for degradation caused by wavelength dispersion of the two pairs of the wavelength multiplexed signals. The interleaver 5 multiplexes the two pairs of the wavelength multiplexed signals inputted from the port b and the port c and outputs one pair of the wavelength multiplexed signals whose wavelength interval is narrowed from the port a. The optical amplifier 6 amplifies the wavelength multiplexed signal inputted from the interleaver 5 kept in the light state and outputs it.

Since known amplifiers can be applied to the optical amplifiers 1 and 6, detailed description will be omitted.

A path from an input of the optical amplifier 1 to an output of the optical amplifier 6 constitutes a single stage of a relay, and the optical transmission system is configured by connecting transmission path fibers 7 and 8 to the input side of the optical amplifier 1 and the output side of the optical amplifier 6, respectively. To this optical transmission system, a wavelength multiplexed signal with a wavelength interval of 50 gigahertz and 80 channels is transmitted. In order to reduce a nonlinear loss in the transmission path fibers 7 and 8, the output of the optical amplifier 6 is limited to 0 dBm per channel. Since the loss of the transmission path fibers 7 and 8 is 15 dB, the input of the optical amplifier 1 is −15 dBm per channel. Also, the noise index of the optical amplifiers 1 and 6 is 7 dB, the loss of the dispersion compensation fibers 3 and 4 is 12 dB, and the loss of the interleavers 2 and 5 is 1 dB, respectively.

The suppression ratio to a signal light of four optical wave mixing causing the nonlinear degradation is in proportion to the square of the input to the optical fiber, in inverse proportion to the fourth power of the wavelength interval and in inverse proportion to the fourth power of a mode field radius of the optical fiber. Since the mode field radius of the transmission path fibers 7 and 8 is 10 μm while the mode field radius of the dispersion compensation fibers 3 and 4 is 5 μm, the four optical wave mixing of as much as 16 times of that of the transmission path fibers 7 and 8 is generated in the dispersion compensation fibers 3 and 4.

In this exemplary embodiment, since the wavelength interval in the dispersion compensation fibers 3 and 4 is 100 gigahertz, while the wavelength interval in the transmission path fibers 7 and 8 is 50 gigahertz, generation of the four optical wave mixing becomes 1/16, and the degradation caused by the mode filed radius is cancelled. In this way, the nonlinear degradation can be reduced.

Moreover, if it is only necessary to reduce the nonlinear degradation to the same level as that of the transmission path, the input of the dispersion compensation fibers 3 and 4 may be set at 0 dBm, which is the same as that of the transmission path fibers 7 and 8. Under this condition, the noise index of the relay as a whole becomes 9.1 dB, and supposing that the noise ratio to the optical signal at the receiving end is 20 dB or more, transmission of 24 spans becomes possible.

As mentioned above, the optical transmission system according to this exemplary embodiment:

(1) can reduce the nonlinear degradation in the relay since the wavelength interval in the dispersion compensation fiber is set wide; and

(2) can reduce noise degradation in the relay since the input to the dispersion compensation fiber is set high.

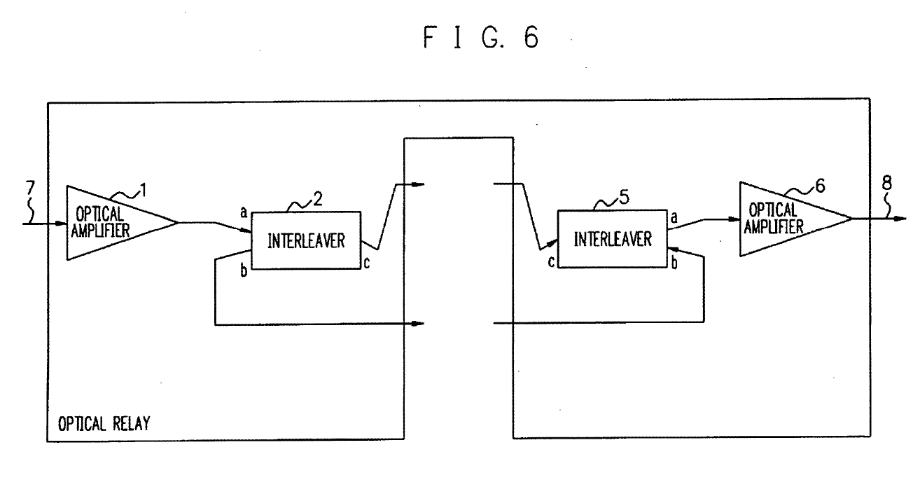

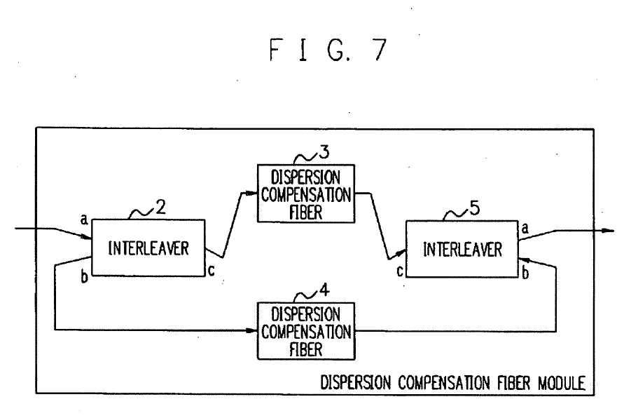

As shown in FIG. 6, it is also possible to have the optical relay including two pairs of the dispersion compensation fiber connection ports between the optical amplifier 1 and the optical amplifier 6. Also, as shown in FIG. 7, it may be so configured as a dispersion compensation fiber module with high nonlinearity resistance incorporating an interleaver. In these configurations, a dispersion compensation amount can be adjusted by replacement of the dispersion compensation fiber while the optical amplifiers 1 and 6 are fixed. Particularly, the configuration shown in FIG. 7 can be handled totally equivalently to conventional-art dispersion compensation fibers.

### Second Exemplary Embodiment

A second exemplary embodiment of the present invention will be described below.

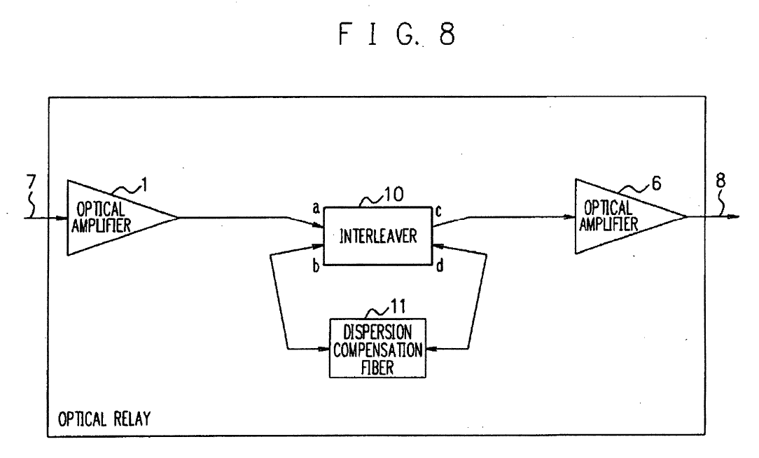

FIG. 8 shows a configuration of an optical transmission system according to a second exemplary embodiment. In the exemplary embodiment, an interleaver 10 provided with four ports and a dispersion compensation fiber 11 are arranged between the optical amplifier 1 and the optical amplifier 6.

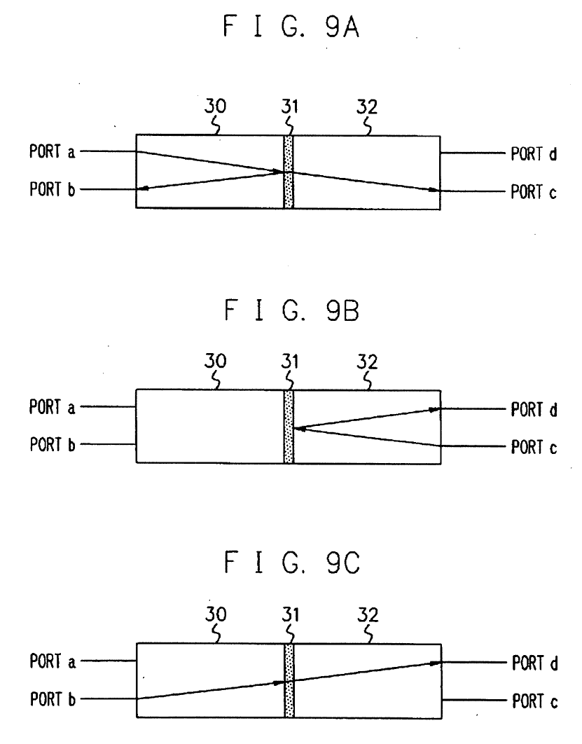

FIG. 9 show configurations of the interleaver 10. As shown in FIG. 9A, a wavelength multiplexed signal inputted from the port a advances through a rod lens 30. An odd-number channel is reflected by a multiplexer/demultiplexer film 31 and outputted from the port b, while an even-number channel is transmitted through the multiplexer/demultiplexer film 31 and then, advances through a rod lens 32 and is outputted from the port c, respectively. In addition, as shown in FIG. 9B, the wavelength multiplexed signal of the odd-number channel inputted from the port c advances through the rod lens 32, reflected by the multiplexer/demultiplexer film 31 and outputted from a port d. Moreover, as shown in FIG. 9C, the wavelength multiplexed signal of the even-number channel inputted from the port b advances through the rod lens 30, transmitted through the multiplexer/demultiplexer film 31 and outputted from the port d.

The optical amplifier 1 amplifies the inputted wavelength multiplexed signal in the light state and outputs it to the interleaver 10. The interleaver 10 demultiplexes the wavelength multiplexed signal inputted from the port a into the odd-number channel and the even-number channel and outputs two pairs of the wavelength multiplexed signals whose wavelength interval is enlarged from the port b and the port c, respectively. The dispersion compensation fiber 11 compensates for degradation caused by wavelength dispersion of the two pairs of the wavelength multiplexed signals, but the odd-number channel and the even-number channel are inputted from separate ends of the dispersion compensation fiber 8, respectively, transmitted in the opposite direction and outputted from the opposite side. The interleaver 10 multiplexes the two pairs of the wavelength multiplexed signals inputted from the port b and the port c and outputs the one pair of the wavelength multiplexed signals whose wavelength interval is narrowed from the port d. The optical amplifier 6 amplifies the wavelength multiplexed signal inputted from the interleaver 10 and outputs it kept in the light state.

Since an operation and an effect of the optical transmission system are the same as those of the first exemplary embodiment, the description will be omitted.

In this exemplary embodiment, by using the dispersion compensation fiber 11 in both directions by the interleaver 10 with the four ports, the nonlinear degradation can be reduced with a simple configuration in which only one interleaver is added.

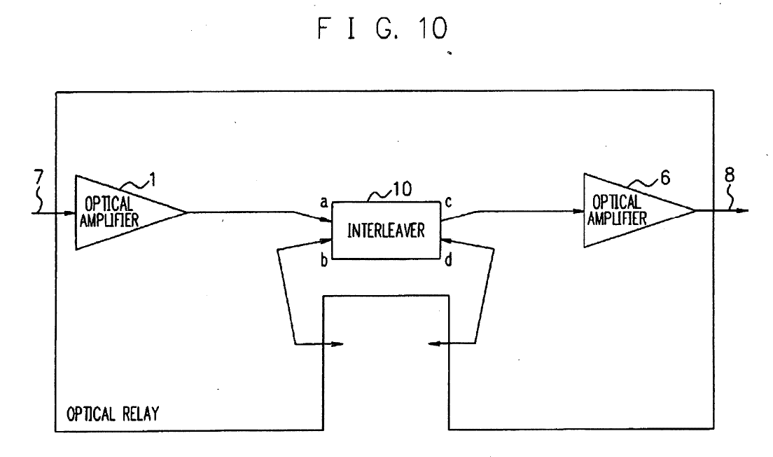

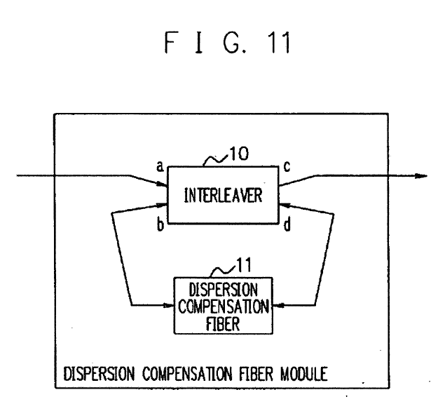

As shown in FIG. 10, it is possible to configure the optical relay including one pair of dispersion compensation fiber connection ports between the optical amplifier 1 and the optical amplifier 6. As shown in FIG. 11, it is possible to configure a dispersion compensation fiber module with high nonlinear resistance, incorporating an interleaver. In these configurations, it is also possible to adjust the dispersion compensation amount by replacement of the dispersion compensation fiber while the optical amplifiers 1 and 6 are fixed. Particularly, the configuration shown in FIG. 11 can be handled totally equally as the conventional-art dispersion compensation fiber.

The case in which the interleaver is configured as an internal mirror-type passive component using a rod lens is shown as an example in each of the above exemplary embodiments, but the present invention is not limited to the configuration of a specific interleaver.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An optical communication apparatus comprising:
a wavelength interval enlarging unit which enlarges a wavelength interval of an inputted wavelength multiplexed signal;
a unit which applies arbitrary processing involving nonlinear degradation to the wavelength multiplexed signal whose wavelength interval is enlarged; and
a wavelength interval recovering unit which recovers the wavelength interval of the wavelength multiplexed signal to which the arbitrary processing is applied to the original wavelength interval.

2. The optical communication apparatus according to claim 1, wherein
the wavelength interval enlarging unit demultiplexes the inputted wavelength multiplexed signal into two or more; and
the wavelength interval recovering unit multiplexes the wavelength multiplexed signal demultiplexed into two or more.

3. The optical communication apparatus according to claim 2, wherein
the wavelength interval enlarging unit is an interleaver for outputting adjacent wavelength components in separate directions.

4. The optical communication apparatus according to claim 3, wherein
a wavelength component after the arbitrary processing is applied is inputted to the interleaver from separate ports so that the interleaver functions as the wavelength interval recovering unit.

5. The optical communication apparatus according to claim 1, wherein
the wavelength interval enlarging unit and the wavelength interval recovering unit are wavelength converters for converting a wavelength interval of the inputted wavelength multiplexed signal.

6. The optical communication apparatus according to claim 1, wherein
the wavelength interval enlarging unit and the wavelength interval recovering unit are made into a module and configured integrally.

7. The optical communication apparatus according to claim 6, wherein
the unit which applies arbitrary processing is made into a module and integrated with the wavelength interval enlarging unit and the wavelength interval recovering unit.

8. The optical communication apparatus according to claim 1, further comprising
a first amplifier for amplifying the inputted wavelength multiplexed signal.

9. The optical communication apparatus according to claim 8, wherein
the first amplifier is made into a module and integrated with the wavelength interval enlarging unit and the wavelength interval recovering unit.

10. The optical communication apparatus according to claim 1, further comprising
a second amplifier for amplifying the wavelength multiplexed signal whose wavelength interval is recovered to original.

11. The optical communication apparatus according to claim 10, wherein
the second amplifier is made into a module and integrated with the wavelength interval enlarging unit and the wavelength interval recovering unit.

12. An optical transmission system comprising:
the optical communication apparatus according to claim 1;
a first transmission path fiber for inputting a wavelength multiplexed signal to the optical communication apparatus; and
a second transmission path fiber for outputting the wavelength multiplexed signal from the optical communication apparatus.

13. A method for reducing nonlinear degradation comprising steps of:
enlarging a wavelength interval of an inputted wavelength multiplexed signal;
applying arbitrary processing involving nonlinear degradation to the wavelength multiplexed signal whose wavelength interval is enlarged; and
recovering the wavelength interval of the wavelength multiplexed signal to which the arbitrary processing is applied to an original wavelength interval.

14. An optical communication apparatus comprising:
wavelength interval enlarging means for enlarging a wavelength interval of an inputted wavelength multiplexed signal;
means for applying arbitrary processing involving nonlinear degradation to the wavelength multiplexed signal whose wavelength interval is enlarged; and
wavelength interval recovering means for recovering the wavelength interval of the wavelength multiplexed signal to which the arbitrary processing is applied to the original wavelength interval.
